(19) United States
(12) Patent Application Publication
(10) Pub. No.: US 2006/0007462 A1
(43) Pub. Date: Jan. 12, 2006

(54) Method and apparatus for printing borderless image

(75) Inventor: Seung-don Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/099,547

(22) Filed: Apr. 6, 2005

(30) Foreign Application Priority Data
Jul. 9, 2004 (KR) 2004-53363
Jul. 10, 2004 (KR) 2004-53774

(51) Int. Cl. G06F 15/00

(52) U.S. Cl. 358/1.12; 358/1.18

(57) ABSTRACT

Disclosed is a method and apparatus for printing an image without borders. In the method, an image to be printed is divided into at least two image regions and these image regions are expanded and printed using different image expansion methods. The method comprises the steps of dividing the image into at least two image regions, computing the values of expansion pixels of the image regions using image expansion methods corresponding to the respective image regions, expanding the image using the computed values, and printing the expanded image.

### CROSS-REFERENCE TO RELATED APPLICATION

This application claims the benefit under 35 U.S.C. §119(a) of Korean Patent Application No. 2004-53363, filed on Jul. 9, 2004, and Korean Patent Application No. 2004-53774 filed on Jul. 10, 2004, in the Korean Intellectual Property Office, the entire disclosures of which are hereby incorporated by reference.

### BACKGROUND OF THE INVENTION

1. Field of the Invention

The present invention relates to a method and apparatus for printing an image. More particularly, the present invention relates to a method and apparatus for printing an image without borders.

2. Description of the Related Art

The popularity of digital cameras has created a need for the capability to output digital photographs, thereby resulting in the increased use of photo printers. A main function of the photo printer is to print an image without borders.

To print an image without borders, a user determines the size of the paper the image will be printed on and selects a borderless printing mode via a predetermined graphic user interface. When the borderless printing mode is selected, an image 120 is obtained by enlarging the size of an object image to be slightly larger than the size of the selected printing paper 10 as shown in FIG. 1. In other words, it is possible to print an object image without borders by enlarging the object image to be larger than the printing paper and printing the enlarged image on the printing paper.

Conventionally, in order to print an image without borders, an object image is enlarged to be slightly larger than the size of the printing paper using an image enlargement method. There are various ways of enlarging an image. If the image is enlarged to obtain a high-quality image, the quality of the image is satisfactory but a large amount of computation is required to obtain the values of the generated pixels. However, if the image is enlarged to obtain a low-quality image, the values of the generated pixels can be quickly and easily computed. That is, there is a trade-off between the quality of enlarged image and the speed at which the enlarged image is processed.

In general, in the case of an image, such as a photograph, where the eyes of a viewer are focused on the center of the image, the focus of the image is likely to be set to the center of image. Accordingly, there is a need to develop a method and apparatus for dividing an image that is to be printed into several regions, enlarging the regions using different image enlargement methods, and printing the enlarged regions of the image.

Also, needed is a method for printing an image without borders comprising the steps of selecting an image enlargement method selected in consideration of the characteristics of the printing paper on which an image is to be printed, enlarging the image using the selected image enlargement method, and printing the enlarged image.

### SUMMARY OF THE INVENTION

The present invention provides a method and apparatus for printing an image without borders by dividing the image into at least two regions and enlarging the two regions using different image enlargement methods.

The present invention also provides a method and apparatus for printing an image without borders by enlarging the image using an image enlargement method selected in consideration of a desired quality of the image to be obtained.

The present invention also provides a method and apparatus for printing an image without borders by enlarging the image using an image enlargement method selected in consideration of a desired quality of image to be obtained and the type of printing paper on which the image will be printed.

According to one aspect of the present invention, there is provided an apparatus for printing an image without borders on printing paper, the apparatus comprising an image division unit for dividing the image into image regions with predetermined sizes according to a predetermined pattern; an image expansion unit for obtaining an expanded image by computing the values of the expansion pixels of the image regions using image expansion methods corresponding to the respective image regions; and a printing unit for printing the expanded image.

The apparatus may further comprise a division region selector for selecting the pattern and sizes of the image regions into which the image is divided.

The apparatus may further comprise an image expansion method selector for selecting the image expansion methods by which the respective image regions are expanded from a plurality of image expansion methods.

The image expansion unit can include a searching unit for searching for the expansion pixels from the image regions, and a calculator for calculating the values of the expansion pixels according to the image expansion methods matching the respective image regions.

According to another aspect of the present invention, there is provided a method for printing an image without borders on printing paper, the method comprising the steps of dividing the image into at least two image regions, obtaining an expanded image by computing the values of the expansion pixels of the image regions according to image expansion methods matching the respective image regions, and printing the expanded image.

According to yet another aspect of the present invention, there is provided a method for printing an image without borders comprising the steps of selecting a print mode according to print quality in response to a user command, enlarging the image using an image expansion method corresponding to the selected print mode, and printing the enlarged image.

According to still another aspect of the present invention, there is provided a method of printing an image without borders comprising the steps of selecting a print mode according to print quality in response to a user command, selecting a print mode according to the type of printing paper in response to a user command, enlarging the image using an image expansion method corresponding the print modes selected according to the print quality and the type of printing paper, and printing the enlarged image.

### BRIEF DESCRIPTION OF THE DRAWINGS

The above and other aspects and advantages of the present invention will become more apparent by describing in detail exemplary embodiments thereof with reference to the attached drawings in which:

FIG. 1 illustrates the outlines of an image and a print medium on which the image is printed in a borderless image printing mode in which an image is printed without borders;

FIG. 2 is a block diagram of an apparatus for printing an image without borders according to an embodiment of the present invention;

FIGS. 3A and 3B illustrate the patterns and sizes of regions into which an input image is divided according to an embodiment of the present invention;

FIG. 4 is a flowchart illustrating a method for printing an image without borders according to an embodiment of the present invention;

FIG. 5 is a flowchart illustrating a method for printing an image without borders according to another embodiment of the present invention;

FIGS. 6A through 6C are flowcharts illustrating methods of enlarging image regions into which an image is divided according to embodiments of the present invention;

FIG. 7 is a block diagram of an apparatus for printing an image without borders according to another embodiment of the present invention;

FIG. 8 is a block diagram of a print mode selector of the apparatus of FIG. 7 according to an embodiment of the present invention;

FIG. 9 is a block diagram of a print mode selector of the apparatus of FIG. 7 according to another embodiment of the present invention;

FIG. 10 is a flowchart illustrating a method of printing an image without borders according to an embodiment of the present invention;

FIG. 11 is a flowchart illustrating a method of printing an image without borders according to another embodiment of the present invention;

FIG. 12A is a flowchart illustrating a method of enlarging an image according to a print mode selected for print quality to be obtained and the type of printing paper according to an embodiment of the present invention; and

FIG. 12B is a flowchart illustrating a method of enlarging an image according to a print mode selected for print quality to be obtained and the type of printing paper according to another embodiment of the present invention.

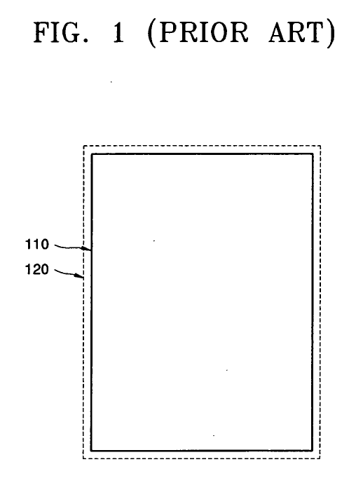

Throughout the drawings, it should be understood that like reference numbers refer to like features, structures and elements.

### DETAILED DESCRIPTION OF EXEMPLARY EMBODIMENTS

Exemplary embodiments of the present invention will now be described in detail with reference the accompanying drawings.

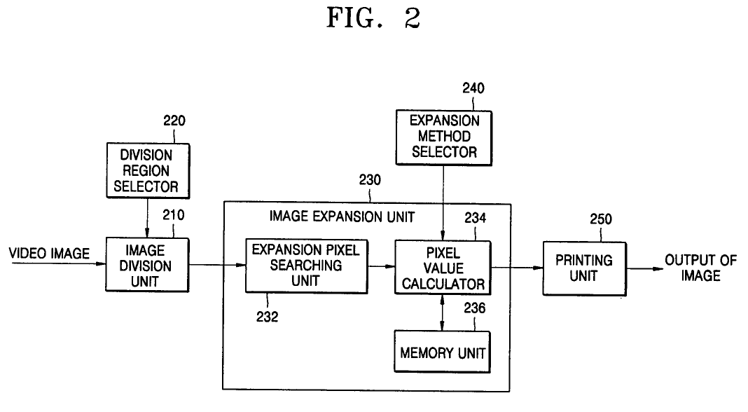

FIG. 2 is a block diagram of an apparatus for printing an image without borders according to an embodiment of the present invention. The apparatus comprises an image division unit 210, a division region selector 220, an image expansion unit 230, an expansion method selector 240, and a printing unit 250. The image expansion unit 230 comprises an expansion pixel searching unit 232, a pixel value calculator 234, and a memory unit 236.

When an image is input to the image division unit 210, the image division unit 210 divides the input image into at least two image regions based on the size of printing paper. Prior to the image being printed, the size of the printing paper may be selected via a user interface or be automatically determined by the apparatus. Also, the patterns and sizes of the image regions into which the input image is divided may have been predetermined or may be selected by a user using the division region selector 220 prior to the printing of the image.

The image expansion unit 230 calculates the expansion pixel values of the pixels in each of the divided image regions using an image expansion method corresponding to each of the divided image regions. The expansion of the image leads to the creation of expansion pixels with unknown values. Interpolation is preferably used to calculate the values of the expansion pixels. In this case, various methods for interpolation, such as repetitive interpolation, bi-linear interpolation, bi-cubic interpolation or other suitable interpolation methods, can be used. However, the present invention is not limited to the above described methods of interpolation, and those of skill in the art will appreciate that other image expansion methods may be used.

In repetitive interpolation, the values of the pixels closest to the expansion pixels are determined as the values of expansion pixels. Thus, repetitive interpolation allows the values of expansion pixels to be quickly calculated. However, repetitive interpolation may cause the printed input image to be different from the input image.

In bi-linear interpolation, the values of the expansion pixels are calculated by giving weights to the values of four pixels adjacent to each of the expansion pixels, multiplying the values of the four pixels by the given weights, respectively, and adding the results of multiplication together. The value of a pixel with the coordinate (x, y) positioned between two pixels with coordinates (x₀, y₀) and (x₁, y₁) on a one-dimensional plane, is computed using Equation (1). The value of the pixel positioned on a two-dimensional plane is computed by performing Equation (1) twice, once in each dimension.
y=y₀+(y₁−y₀)/(x₁−x₀)×(x₁−x₀) (1)

In bi-cubic interpolation, the values of the expansion pixels are more precisely computed using a cubic function and the values of sixteen pixels around each of the expansion pixels. Equation (2) is used to compute the value of an expansion pixel on a one-dimensional plane. That is, the value of the new pixel is obtained using the values of four pixels with coordinates (x₀, y₀), (x₁, y₁), (x₂, y₂), and (x₃, y₃) around the new pixel. A matrix representation of Equation (2) may be expressed by Equation (3). The coefficient a of the cubic equation is obtained by multiplying the reverse matrix of the matrix [X] in Equation (3) by the matrix [Y] as expressed in Equation (4).
y₀=a₀+a₁x₀+a₂x₀+a₃x₀³,
y₁=a₀+a₁x₁+a₂x₁²+a₃x₁³,
y₂=+a₀+a₁x₂+a₂x₂²+a₃x₂³,
y₃=a₀+a₁x₃+a₂x₃²+a₃x₃³ (2)
[X] [a]=[Y] (3)
[a]=inv([X])[Y] (4)

That is, in bi-cubic interpolation, the value of the new pixel on the one-dimensional plane is obtained by computing the values of the four pixels around the new pixel using Equation (2), and then, the value of the new pixel on the two-dimensional plane is obtained using the four pixel values.

The expansion pixel searching unit 232 of the image expansion unit 230 searches for the expansion pixels from expanded image regions obtained by expanding the image regions divided by the image division unit 220. The pixel value calculator 234 calculates the values of the searched expansion pixels according to the image expansion methods corresponding to the divided image regions. For instance, the expansion pixel searching unit 232 searches for expansion pixels at the center of the expanded image and expansion pixels at the edge thereof. The pixel value calculator 234 computes the values of the expansion pixels at the center using either a bi-linear interpolation or bi-cubic interpolation method, and the values of the expansion pixels at the edge of the image are computed using the repetitive interpolation method. The memory unit 236 stores a plurality of image expansion methods.

The image expansion methods may have been predetermined according to the patterns of the image regions into which the input image was divided, or selected from the plurality of image expansion methods stored in the memory unit 236 by a user using the expansion method selector 240 whenever an image is to be printed. The input image is expanded using the image expansion methods corresponding to the divided image regions. The expanded image data is processed, such as color matching and halftoning, and the resulting processed image is printed by the printing unit 250.

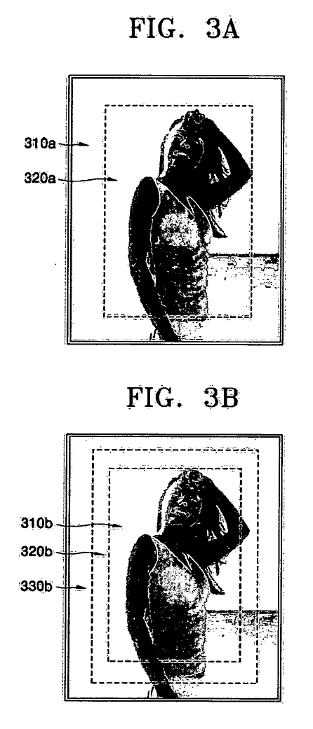

FIGS. 3A and 3B illustrate the patterns and sizes of image regions into which an input image is divided according to an embodiment of the present invention. In more detail, FIG. 3A illustrates the patterns of a low-definition image region 310a and a high-definition image region 320a into which the input image is divided. FIG. 3B illustrates the patterns of a low-definition image region 330b, a middle-definition image region 320b, and a high-definition image region 310b.

In other words, referring to FIG. 3A, a center portion of the image is the high-definition image region 320a and an edge portion thereof is the low-definition image region 310a. Referring to FIG. 3B, a center portion of the image is the high-definition image region 310b, an edge portion thereof is the low-definition image region 330b, a portion between the center portion and the edge portion is the middle-definition image region 320b.

According to embodiments of the present invention, a user can determine the desired patterns and sizes of the image regions into which an input image is divided, using the division region selector 220. The patterns and sizes of image regions shown are intended to be exemplary and are not limited to those shown in FIGS. 3A and 3B.

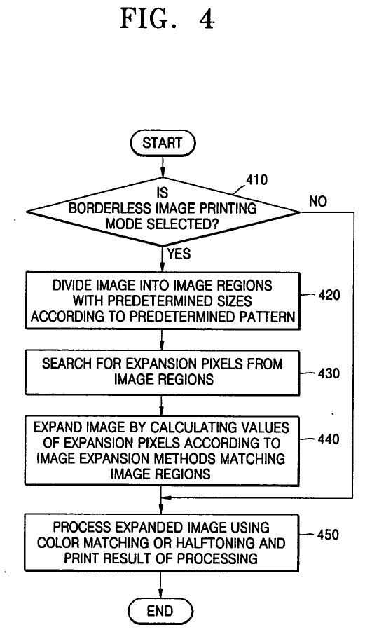

FIG. 4 is a flowchart illustrating a method of printing an image according to an embodiment of the present invention. Referring to FIG. 4, it is determined whether a borderless image printing mode is selected via a predetermined user interface (operation 410). When it is determined in operation 410 that the borderless image printing mode is selected, the image is divided into at least two image regions (operation 420). Next, expansion pixels are searched for from the divided image regions (operation 430). For printing an image without borders, the image must be expanded to be slightly larger than the size of the printing paper, and image expansion results in expansion pixels to be present in the divided image regions. Next, the values of the expansion pixels are computed according to the image expansion methods corresponding to the divided image regions, respectively, thus obtaining an expanded image (operation 440). As described above, repetitive interpolation, bi-bipolar interpolation, and bi-cubic interpolation are examples of interpolation methods used to compute the values of the expansion pixels. However, the types of interpolation applied to the present invention are not limited to the above image expansion methods. The expanded image obtained in operation 440 is processed by image data processing such as color matching and halftoning, and then, the resulting image data is printed (operation 450).

If the borderless printing mode is not selected via the predetermined user interface, the image is printed using a conventional image printing method.

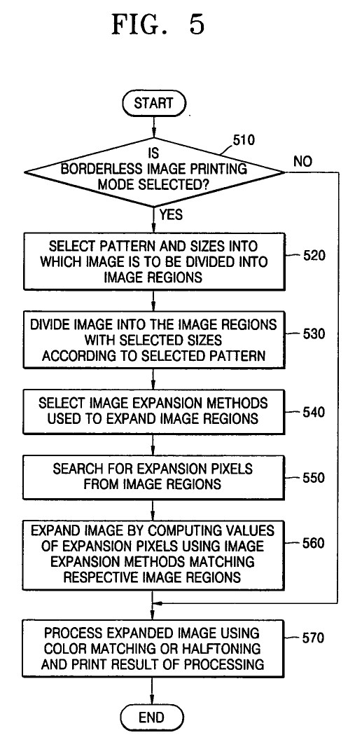

FIG. 5 is a flowchart illustrating a method of printing an image according to another embodiment of the present invention. Referring to FIG. 5, it is determined whether a borderless image printing mode is selected via a predetermined user interface (operation 510). When it is determined in operation 510 that the borderless image printing mode is selected, the pattern and sizes into which the image is to be divided into image regions are selected (operation 520). The patterns of the image regions may be selected as either of a high-definition image region and a low-definition image region, or a high-definition image region, a middle-definition image region, and a low-definition image region, using the division region selector 220 of FIG. 2. However, embodiments of the present invention are not limited to the above patterns, that is, the image can be divided into a plurality of image regions according to various patterns. The sizes of image regions into which the image is to be divided are selected using the division region selector 220 of FIG. 2. According to embodiments of the present invention, the sizes of image regions also are not limited. Thereafter, the image is divided into the image regions of the selected sizes according to the selected pattern determined in operation 520 (operation 530).

After operation 530, image expansion methods that will be used to expand the divided image regions, respectively, are selected from a plurality of image expansion methods (operation 540). For image expansion, various types of interpolation may be used according to embodiments of the present invention. Expansion pixels are searched for from the divided image regions (operation 550). An expanded image is obtained by computing the values of the searched expansion pixels using the image expansion methods matching the respective image regions, selected in operation 540 (operation 560). The expanded image is processed by image data processing such as color matching and halftoning, and the resulting processed image data is printed (operation 570).

If the borderless printing mode is not selected via the predetermined user interface, the image is printed using a conventional image printing method. Operations 510, 530, 550, and 560 generally correspond to operations 410, 420, 430, and 440 of FIG. 4, respectively.

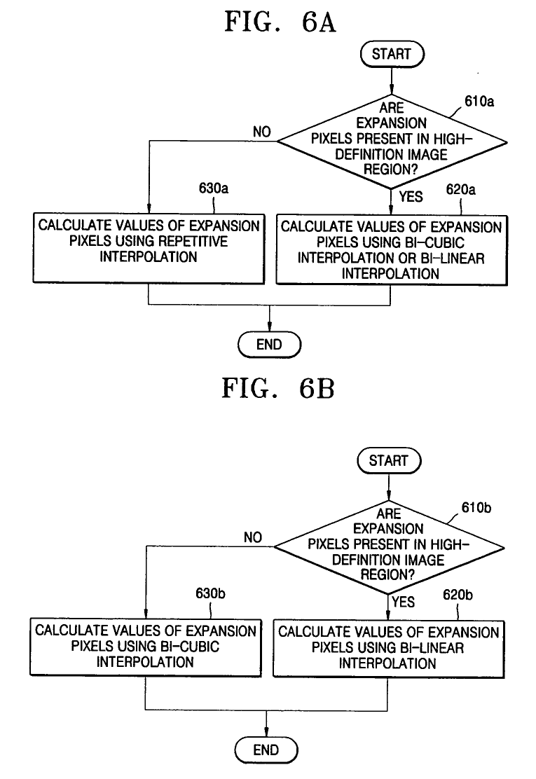

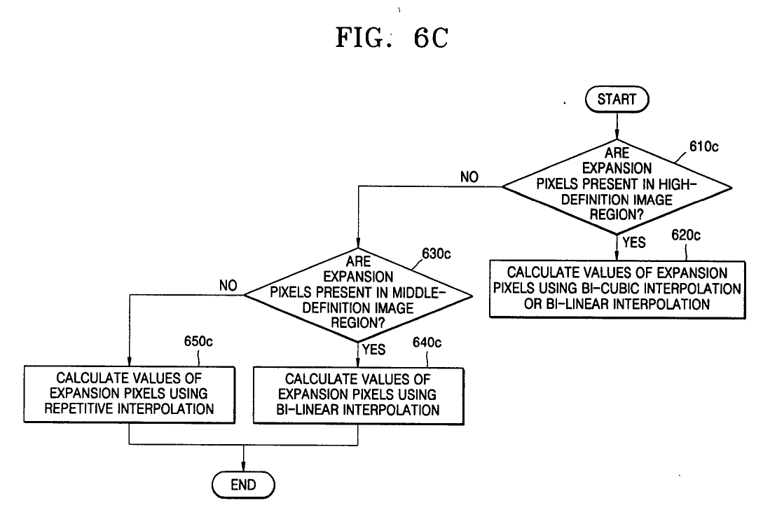

FIGS. 6A and 6B are detailed flowcharts illustrating a method of enlarging an image according to the patterns of image regions into which the image is divided, as performed in operation 440 of the method of FIG. 4 or operation 560 of the method of FIG. 5, according to embodiments of the present invention. More specifically, FIGS. 6A and 6B illustrate methods of enlarging a high-definition image region and a low-definition image region into which an image is divided, respectively, according to an embodiment of the present invention. FIG. 6C illustrates a method of enlarging a high-definition image region, a middle-definition image region, and a low-definition image region into which an image is divided according to an embodiment of the present invention.

In the method of FIG. 6A, in operation 610a, it is determined whether expansion pixels are present in the high-definition image region using the expansion pixel searching unit 232 of FIG. 2. If the high-definition image region contains the expansion pixels, the values of the expansion pixels are computed using bi-cubic interpolation or bi-linear interpolation (operation 620a). If the high-definition image region does not contains the expansion pixels, the values of the expansion pixels are preferably computed using the repetitive interpolation method (operation 630a).

In the method of FIG. 6B, in operation 610b, it is determined whether expansion pixels are present in the high-definition image region using the expansion pixel searching unit 232. If the high-definition image region contains the expansion pixels, the values of the expansion pixels are computed using bi-cubic interpolation (operation 620b). If the high-definition image region does not contain the expansion pixels, the values of the expansion pixels are preferably computed using the bi-linear interpolation method (operation 630b).

In the method of FIG. 6C, in operation 610c, it is determined whether expansion pixels are present in the high-definition image region using the expansion pixel searching unit 232. If the high-definition image region contains the expansion pixels, the values of the expansion pixels are preferably computed using the bi-cubic interpolation method (operation 620c). If the high-definition image region does not contain the expansion pixels, and it is determined that the expansion pixels are contained in the middle-definition image region (operation 630c), the values of the expansion pixels are preferably computed using the bi-linear interpolation method (operation 640c). However, when the expansion pixels are not contained in the middle-definition image region or the high-definition image region, the values of the expansion pixels are preferably computed using the repetitive interpolation method (operation 650c).

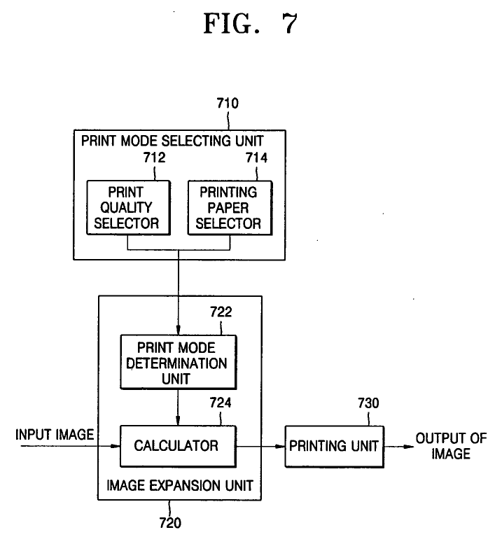

FIG. 7 is a block diagram of an apparatus for printing an image without borders according to another embodiment of the present invention. The apparatus comprises a print mode selecting unit 710, an image expansion unit 720, and a printing unit 730. The print mode selecting unit 710 comprises a print quality selector 712 and a printing paper selector 714. A user command that instructs a print mode to be selected according to the print quality and the printing paper is input via the print quality selector 712 and the printing paper selector 714. The image expansion unit 720 determines the print mode selected by the print mode selecting unit 710 and computes the values of the expansion pixels using an image expansion method corresponding to the determined print mode. The image expansion method may have been predetermined by a manufacturer of the apparatus or a predetermined image expansion method can be selected according to a predetermined print mode by a user. The values of expansion pixels can be computed using various types of interpolation methods, such as repetitive interpolation, bi-linear interpolation, and bi-cubic interpolation methods, as described above.

The print mode determination unit 722 of the print expansion unit 720 determines the print mode according to the print quality and printing paper selected by the print quality selector 712 and the printing paper selector 714. A calculator 724 of the print expansion unit 720 calculates the values of the expansion pixels obtained by image expansion, using the image expansion method determined by the print mode, and obtains an expanded image using the pixel values. The printing unit 730 processes the expanded image using color matching or halftoning and prints the resulting processed image data.

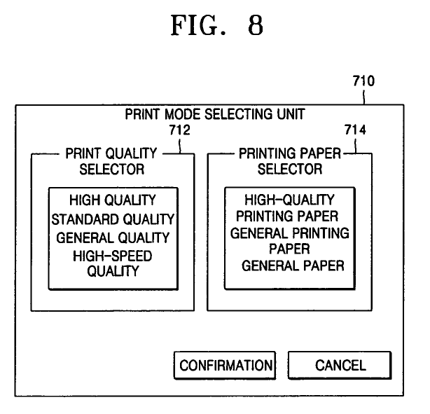

FIG. 8 is a block diagram of the print mode selecting unit 710 of the apparatus of FIG. 7 according to an embodiment of the present invention. The print mode selecting unit 710 comprises a print quality selector 712 and a printing paper selector 714 to which a user command is input. A user may input a user command that selects the quality of image to which an image is to be enlarged, via the print quality selector 712. For instance, the quality of image may be determined as high quality, standard quality, general quality, or high-speed draft quality. Also, the user may input a user command that selects the type of paper on which the image is to be printed, via the printing paper selector 714. For instance, the type of paper may be determined as high-quality printing paper, general printing paper, or general paper. The user will also have the option to confirm or cancel the quality and printing paper selections.

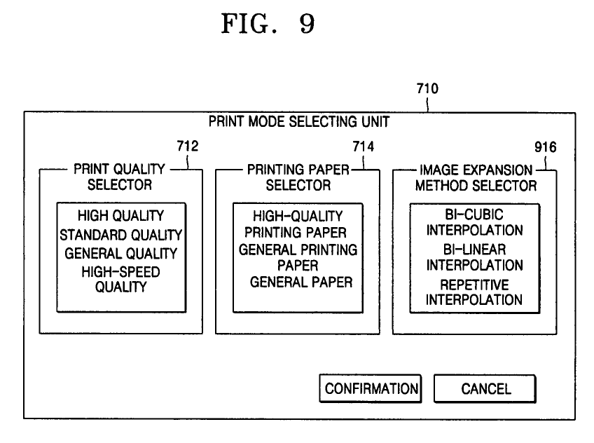

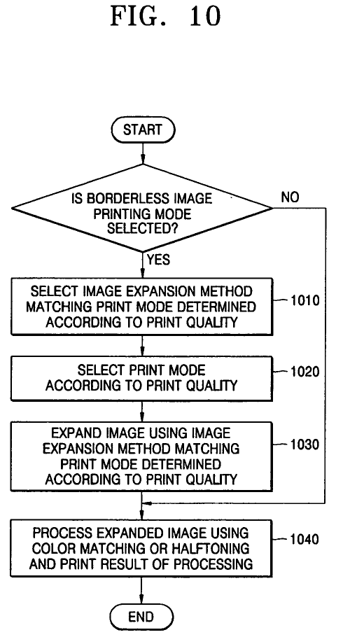

FIG. 9 is a block diagram of the print mode selecting unit 710 of the apparatus of FIG. 7 according to another embodiment of the present invention. The print mode selecting unit 710 comprises a print quality selector 712 and a printing paper selector 714, and further comprises an image expansion method selector 916. A user may input a user command that selects a print expansion method corresponding to the desired print quality and paper quality selected, via the image expansion method selector 916. For instance, the image expansion method may be bi-cubic interpolation, bi-linear interpolation, repetitive interpolation or other suitable method. Again, the user has the option to confirm or cancel the selections.

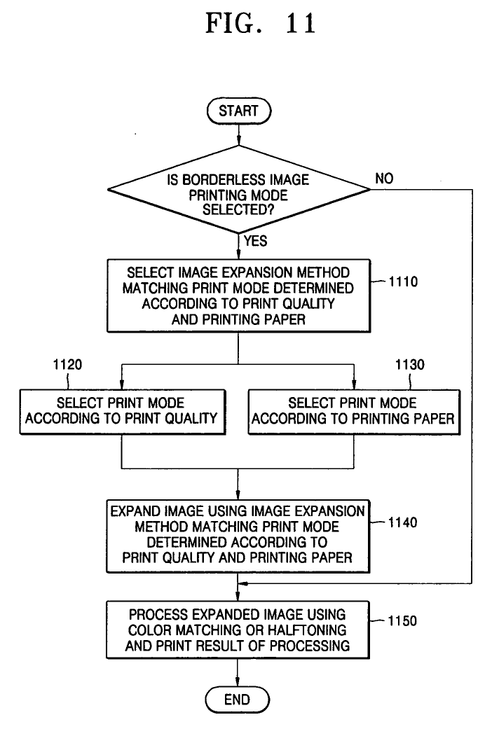

FIG. 10 is a flowchart illustrating a method of printing an image without borders according to an embodiment of the present invention. Referring to FIG. 10, an image expansion method may have been predetermined according to the selected print mode, or be selected from a plurality of image expansion methods by a user or according to the characteristics of image to be printed via the image expansion method selector 916 (operation 1010). A print mode to which an image is to be enlarged is determined according to a user command input via the print quality selector 712 of FIG. 7 (operation 1020). When a predetermined print mode is selected in operation 1020, the image is enlarged according to an image expansion method corresponding to the selected print mode (1030). Next, the expanded image is processed using image data processing such as color matching and halftoning, and the resulting processed image data is printed by the printing unit 730 (1040).

FIG. 11 is a flowchart illustrating a method of printing an image without borders according to another embodiment of the present invention. Referring to FIG. 11, an image expansion method may have been predetermined according to the print mode and a printing paper mode or be selected from a plurality of image expansion methods by a user or according to the characteristics of the image to be printed via the image expansion method selector 916 (operation 1110). The print mode to which an image is to be enlarged is determined according to a user command input via the print quality selector 712 of FIG. 7 (operation 1120). Also, the type of paper on which an image is to be printed is determined according to a user command input via the printing paper selector 714 (1130). The image is expanded using the image expansion method determined by the print mode and printing paper mode selected in operations 1120 and 1130 (operation 1140). Thereafter, the expanded image is processed by image data processing such as color matching and halftoning and the resulting processed image data is printed by the printing unit 730 (1150).

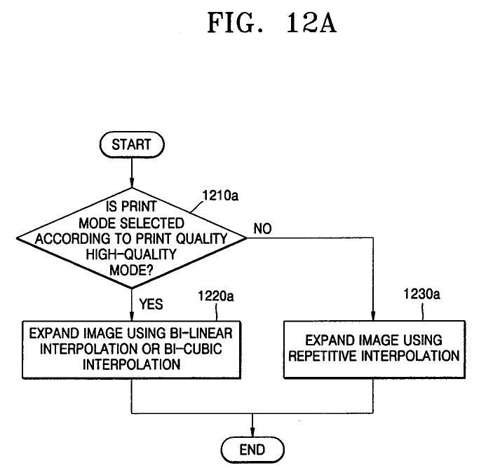

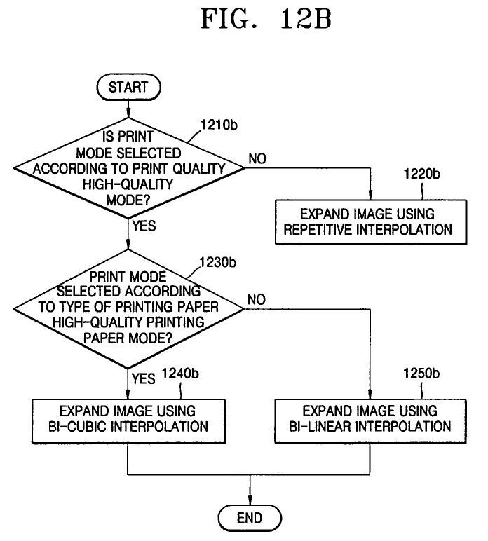

FIGS. 12A and 12B are flowcharts illustrating methods of enlarging an image according to a print mode determined by print quality and the type of printing paper, included in the exemplary methods of FIGS. 10 and 11, respectively. In the exemplary methods of FIGS. 12A and 12B, a print mode is determined and an image expansion method is determined according to the determined print mode; or a print mode is determined, a printing paper mode is determined according to the determined print mode, and then, an image expansion method is determined. Alternatively, a printing paper mode may be determined and an image expansion method may be determined according to the determined printing paper mode, or a printing paper mode may be determined, a print mode is determined according to the printing paper mode, and then, an image expansion method may be determined.

Referring to FIG. 12A, it is determined whether a print mode selected according to the print quality is a high-quality mode (operation 1210a). When the selected print mode is the high-quality mode, an image that is to be printed is preferably enlarged using the bi-linear interpolation or bi-cubic interpolation methods (1220a). If the print mode is a mode other than the high-quality mode, the image is preferably enlarged using the repetitive interpolation method (operation 1230a).

Referring to FIG. 12B, it is determined whether a print mode selected according to print quality is a high-quality mode (operation 1210b). When it is determined in operation 1210b that the selected print mode is the high-quality mode, it is determined whether a print mode is selected according to whether the type of printing paper is a high-quality printing paper mode (operation 1230b). When it is determined in operation 1230b that the print mode is the high-quality printing paper mode, the image is preferably enlarged using the bi-cubic interpolation method (operation 1240b). However, when the print mode is a mode other than the high-quality printing paper mode, the image is enlarged using the bi-linear interpolation method (operation 1250b). When it is determined in operation 1210b that the selected print mode is a mode other than the high-quality mode, the image is preferably enlarged using the repetitive interpolation method (operation 1220b).

The present invention can be embodied as a computer program that is executed using a computer, and be recorded on a computer readable medium and executed by a general digital computer. The computer readable medium may be a magnetic storage medium, such as a read-only memory (ROM), a floppy disk, or a hard disk; an optical data storage medium, such as a compact disc (CD)-ROM or a digital versatile disc (DVD); or a carrier wave that transmits data via the Internet.

In a method and apparatus for printing an image without borders according to embodiments of the present invention, an image to be printed is divided into a high-definition image region and a low-definition image region, these regions are enlarged and printed using different image expansion methods, thereby minimizing the reduction in the quality of the image to be printed and the delay in processing the image to be printed.

In the method and apparatus according to embodiments of the present invention, an image to be printed is divided into a high-definition image region and a low-definition image region as users' desire or according to the characteristics of the image, and these regions are expanded and printed according to different image expansion methods.

Also, the method and apparatus according to embodiments of the present invention allow a user to select a print mode according to the print quality and printing paper in consideration of the characteristics of the image or as the user desires, and enlarge and print the image using an image expansion method determined according to the print mode. Accordingly, it is possible to quickly and effectively print the image without borders while minimizing the reduction in the quality of image to be printed.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for printing an image without borders on printing paper, comprising:
an image division unit for dividing the image into image regions with predetermined sizes according to a predetermined pattern;
an image expansion unit for obtaining an expanded image by computing the values of expansion pixels of the image regions using image expansion methods corresponding to the respective image regions; and
a printing unit for printing the expanded image.

2. The apparatus of claim 1, further comprising a division region selector for selecting the pattern and sizes of the image regions into which the image is divided.

3. The apparatus of claim 1, further comprising an image expansion method selector for selecting the image expansion methods by which the image regions are expanded, respectively, from a plurality of image expansion methods.

4. The apparatus of claim 1, wherein the image expansion unit comprises:
a searching unit for searching for the expansion pixels from the image regions; and
a calculator for calculating the values of the expansion pixels according to the image expansion methods corresponding to the respective image regions.

5. The apparatus of claim 1, wherein each of the image expansion methods is one of repetitive interpolation, bi-linear interpolation, and bi-cubic interpolation.

6. The apparatus of claim 1, wherein the pattern into which the image is divided is one of a first pattern comprising a high-definition image region and a low-definition image region, and a second pattern comprising a high-definition image region, a middle-definition image region, and a low-definition image region.

7. A method of printing an image without borders on printing paper, comprising the steps of:
(a) dividing the image into image regions with predetermined sizes according to a predetermined pattern;
(b) obtaining an expanded image by computing values of expansion pixels of the image regions according to image expansion methods corresponding to the respective image regions; and
(c) printing the expanded image.

8. The method of claim 7, prior to step (a) further comprising the steps of:
selecting the pattern in which the image is divided into the image regions; and
selecting the sizes of the image regions into which the image is divided.

9. The method of claim 7, wherein the image expansion methods corresponding to the respective image regions are selected from a plurality of image expansion methods according to a user command.

10. The method of claim 7, wherein step (b) comprises the steps of:
searching for expansion pixels from the image regions; and
calculating the values of the searched expansion pixels according to the image expansion methods corresponding to the respective image regions.

11. The method of claim 7, wherein each of the image expansion methods is one of repetitive interpolation, bi-linear interpolation, and bi-cubic interpolation.

12. The method of claim 7, wherein the pattern into which the image is divided is one of a first pattern comprising a high-definition image region and a low-definition image region, and a second pattern comprising a high-definition image region, a middle-definition image region, and a low-definition image region.

13. A computer readable recording medium storing a program executable by a computer system comprising the steps of the method of claim 7.

14. A method of printing an image without borders, comprising the steps of:
selecting a print mode according to print quality;
expanding an image using an image expansion method corresponding to the selected print mode; and
printing the expanded image.

15. The method of claim 14, wherein the image expansion method corresponding to the print mode is selected from a plurality of image expansion methods according to a user command.

16. A computer readable recording medium storing a program executable by a computer system comprising the steps of the method of claim 14.

17. A method of printing an image without borders, comprising the steps of:
selecting a first print mode according to print quality;
selecting a second print mode according to the type of printing paper;
expanding an image using an image expansion method corresponding to the selected first and second print modes; and
printing the expanded image.

18. The method of claim 17, wherein the image expansion method is selected from a plurality of image expansion methods according to a user command.

19. A computer readable recording medium storing a program executable by a computer system comprising the steps of the method of claim 17.

20. An apparatus for printing an image without borders, comprising:
a print mode selector for selecting a print mode according to print quality and printing paper;
an image expansion unit for expanding the image using an image expansion method corresponding to the selected print mode according to print quality and printing paper; and
a printing unit for printing the expanded image.
